(19) United States
(12) Patent Application Publication
(10) Pub. No.: US 2020/0065611 A1
(43) Pub. Date: Feb. 27, 2020

(54) IMAGE PROCESSING APPARATUS AND IMAGE PROCESSING METHOD

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Makoto OSHIKIRI, Yokohama Kanagawa (JP)

(21) Appl. No.: 16/290,594

(22) Filed: Mar. 1, 2019

(30) Foreign Application Priority Data
Aug. 22, 2018 (JP) 2018-155674

(51) Int. Cl. G06K 9/62; G06K 9/46; G06K 9/00

(52) U.S. Cl. CPC G06K 9/6202; G06K 9/6212; G06K 9/00791; G06K 9/4604; G06K 9/6255; G06K 9/4652

(57) ABSTRACT

An image processing apparatus includes a memory that stores a first dictionary having first feature data of a reference image of a target object and a second dictionary having second feature data of the reference image that is horizontally inverted, an image processor configured to acquire third feature data of an input image, and a pattern matching circuit configured to calculate a first score by comparing the first and third feature data and a second score by comparing the second and third feature data, and determine whether the target object is present in the input image based on the first and second scores.

### CROSS-REFERENCE TO RELATED APPLICATIONS

This application is based upon and claims the benefit of priority from Japanese Patent Application No. 2018-155674, filed Aug. 22, 2018, the entire contents of which are incorporated herein by reference.

### FIELD

Embodiments described herein relate generally to an image processing apparatus and an image processing method.

### BACKGROUND

It is known to perform image recognition for detecting a target object in a captured image, and such a technology is considered important especially in the field of the automobile industry. For safety reasons, recognition of the target, such as a sign, a lane, an automobile, and a pedestrian, needs to be done precisely.

When recognizing an object, an image recognition apparatus acquires feature data of the captured image, and compares the acquired feature data with pre-defined feature data, which is obtained from a reference image of the target object. Such pre-defined feature data is stored in the apparatus as a “dictionary.” It is known that the recognition rate depends on the reference image used to generate the dictionary, and the accuracy of the object recognition tends to decrease when the shape of the target object looks different depending on its orientation.

### DESCRIPTION OF THE DRAWINGS

FIG. 1 is a block diagram illustrating a configuration of an image processing apparatus according to a first embodiment.

FIG. 2 is a view illustrating an example of inverting a plurality of divided areas in the horizontal direction.

FIG. 3 is a view illustrating an example of an object on which an image processing apparatus is mounted.

FIG. 4 is a flowchart illustrating an example of the flow of a processing of creating a dictionary.

FIG. 5 is a flowchart illustrating an example of the flow of a processing of creating an inversion dictionary.

FIG. 6 is a flowchart illustrating an example of the flow of a processing of recognizing an object.

FIG. 7 is a block diagram illustrating a configuration of an image processing apparatus according to a second embodiment.

FIG. 8 is a flowchart illustrating an example of the flow of a processing of recognizing an object.

FIGS. 9A and 9B are views illustrating an example of a symmetric object and an asymmetric object.

### DETAILED DESCRIPTION

Embodiments provide an image processing apparatus capable of stably detecting an object whose shape is very different depending on its orientation.

In general, according to one embodiment, an image processing apparatus includes a memory that stores a first dictionary having first feature data of a reference image of a target object and a second dictionary having second feature data of the reference image that is horizontally inverted, an image processor configured to acquire third feature data of an input image, and a pattern matching circuit configured to calculate a first score by comparing the first and third feature data and a second score by comparing the second and third feature data, and determine whether the target object is present in the input image based on the first and second scores.

Hereinafter, embodiments will be described in detail with reference to the drawings.

### First Embodiment

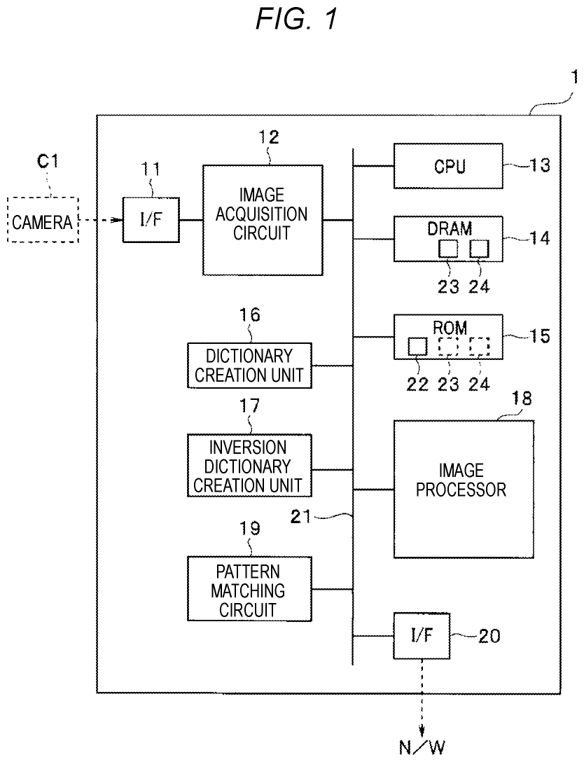

First, a configuration of an image processing apparatus according to a first embodiment will be described with reference to FIG. 1. FIG. 1 is a block diagram illustrating an example of the configuration of the image processing apparatus according to the first embodiment.

As illustrated in FIG. 1, the image processing apparatus 1 includes an interface circuit (hereinafter abbreviated as an “I/F”) 11 which receives an image signal, an image acquisition circuit 12, a central processing unit (hereinafter referred to as a “CPU”) 13, a DRAM 14, a ROM 15, a dictionary creation unit 16, an inversion dictionary creation unit 17, an image processor 18, a pattern matching circuit 19, an I/F 20, and a bus 21. The image acquisition circuit 12, the CPU 13, the DRAM 14, the ROM 15, the dictionary creation unit 16, the inversion dictionary creation unit 17, the image processor 18, the pattern matching circuit 19, and the I/F 20 are connected to the bus 21 and are able to transmit and receive data to and from each other. The dictionary creation unit 16 and the inversion dictionary creation unit 17 may be implemented by dedicated circuits or software, which is loaded onto DRAM 14 and executed by CPU 13. The software may be stored as programs in the ROM 15 or a storage device (now shown).

The image processing apparatus 1 is a semiconductor apparatus which receives an image signal input from a camera C1 mounted in, for example, an automobile (hereinafter referred to as a “car”) and performs a predetermined image recognition processing to output recognition result information.

The I/F 11 receives the input image signal serially transmitted from the camera C1, and outputs the image signal to the image acquisition circuit 12.

The image acquisition circuit 12 acquires the image signal from the I/F 11 to store the image data in the DRAM 14 under the control of the CPU 13. The image data stored in the DRAM 14 is input to the CPU 13 and to the image processor 18 via the bus 21.

The CPU 13 is a control circuit which controls each circuit in the image processing apparatus 1 so as to output a predetermined output signal with respect to the acquired image data. In addition, the CPU 13 performs, for example, the entire image processing and a processing of detecting an object to be described later by executing a predetermined operation program stored in the ROM 15.

The DRAM 14 is a main memory for storing the image data or for storing data related to the processing result of each circuit. In addition, here, the DRAM 14 is provided in a semiconductor chip of the image processing apparatus 1, but may be in a chip different from the semiconductor chip of the image processing apparatus 1 and connected to the bus 21.

The ROM 15 includes a learning image data group 22 for creating a dictionary. The dictionary creation unit 16 divides image data of the learning image data group 22 in the ROM 15 into a plurality of areas, calculates a histogram of oriented gradients (HOG) for each of the plurality of divided areas, creates a dictionary 23 as a reference for identification, and stores the dictionary 23 in the DRAM 14. Here, feature data for each of the plurality of divided areas is HOG feature data which is a histogram including edge and color information obtained from pixels included in each divided area.

The inversion dictionary creation unit 17 creates an inversion dictionary 24 having feature data obtained by inverting the plurality of divided areas of the dictionary 23, and stores the inversion dictionary 24 in the DRAM 14. Here, the inversion dictionary 24 inverts the feature data of each area of the plurality of divided areas of the dictionary 23 in the horizontal direction.

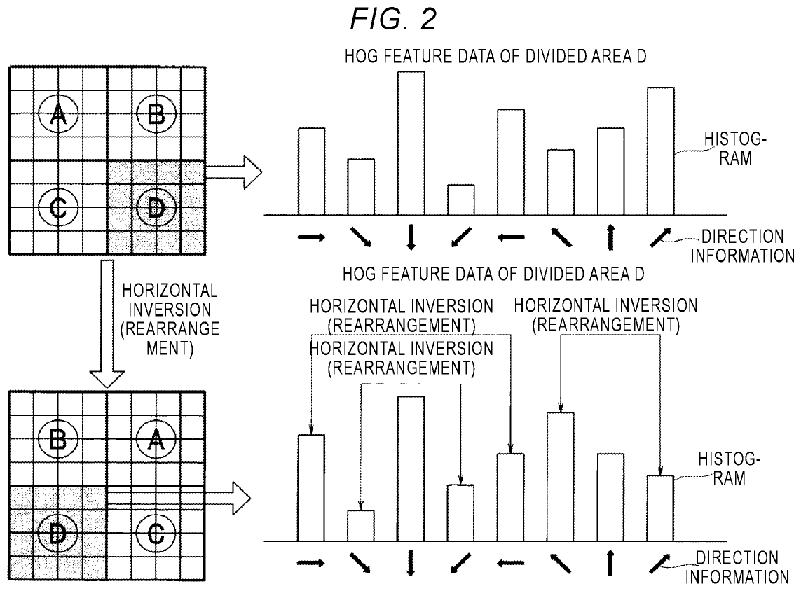

FIG. 2 is a view illustrating an example of inverting the plurality of divided areas in the horizontal direction. As illustrated in FIG. 2, assuming that the plurality of divided areas of the dictionary 23 are divided areas A, B, C, and D, the feature data of each area of the plurality of divided areas A, B, C, and D is inverted in the horizontal direction. Here, in a case where direction information is included in the feature data (i.e., HOG feature data) of the divided area D when creating the inversion dictionary 24, for example, the histogram is rearranged such that the area is inverted, and the direction information is inverted. On the other hand, in a case where no direction information is included in the feature data when creating the inversion dictionary 24, the histogram is rearranged such that the area is inverted. In addition, the direction in which the area is inverted is not limited to the horizontal direction, and the area may be inverted, for example, in the vertical direction or in the vertical and horizontal directions.

In addition, in the present embodiment, the learning image data group 22 is stored in the ROM 15, but it is not limited thereto, and may be stored in, for example, an external memory. In this case, the dictionary creation unit 16 reads the learning image data group 22 from the external memory via the I/F 20 and the bus 21 to create the dictionary 23.

In addition, in the present embodiment, the image processing apparatus 1 performs a processing of creating the dictionary 23 and the inversion dictionary 24, but it is not limited thereto, and for example, an external device may create the dictionary 23 and the inversion dictionary 24 in advance and the dictionary 23 and the inversion dictionary 24 created by the external device may be stored in the ROM 15 in advance. In this case, the image processing apparatus 1 need not include the dictionary creation unit 16 and the inversion dictionary creation unit 17.

The image processor 18 detects a predetermined area of the image data from the DRAM 14 (e.g., an image from the camera C1) as an input image, divides the input image into a plurality of areas, and outputs the input image for which feature data of each of the plurality of areas is acquired to the pattern matching circuit 19.

The pattern matching circuit 19 is a circuit for recognizing a predetermined object. The pattern matching circuit 19 compares the feature data of the dictionary 23 and the inversion dictionary 24 with the feature data of each of the plurality of areas of the input image to calculate respective scores. In other words, the pattern matching circuit 19 performs score determination based on the score obtained by comparing the feature data of the dictionary 23 to the feature data of the input image and the score obtained by comparing the feature data of the inversion dictionary 24 with the feature data of the input image, and determines if there is an object, such as a person or a car, in the image, and outputs the determination result to the DRAM 14.

More specifically, the pattern matching circuit 19 performs score determination by determining the maximum value or the average value of the score obtained by comparing the feature data of the dictionary 23 with the feature data of the input image and the score obtained by comparing the feature data of the inversion dictionary 24 with the feature data of the input image as the final score. Therefore, the image processing apparatus 1 may stably detect an object whose shape is very different depending on its orientation.

The I/F 20 is connected to another system via, for example, a network (N/W). The I/F 20 is a circuit which outputs the matching result of the pattern matching circuit 19. Information on a recognized object, such as a person, and information on the distance to the recognized object are output via the I/F 20. For example, a control device of a car is connected to the network. The control device of the car controls the vehicle using the information from the image processing apparatus 1.

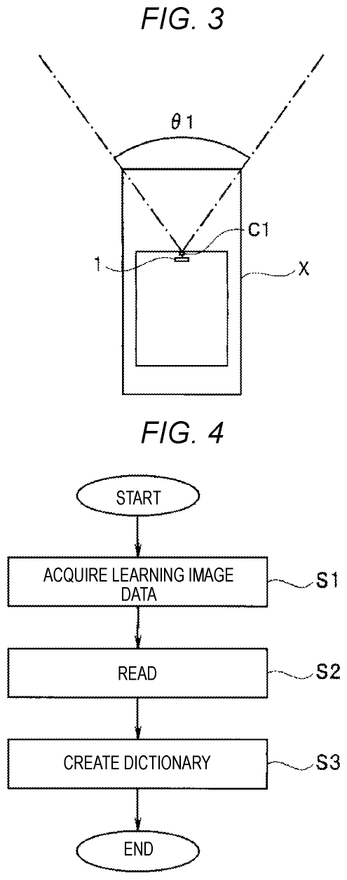

FIG. 3 is a view illustrating an example of an object on which the image processing apparatus is mounted.

Here, the image processing apparatus 1 is mounted as a portion of a forward monitoring system on a car X. The camera C1 having an optical system with an angle of view θ1 is mounted on the car X, and an image signal from the camera C1 is input to the image processing apparatus 1. The camera C1 is used to detect an obstacle ahead of the car X, a person dashing from the side, or a traffic sign.

Next, an operation of the image processing apparatus 1 will be described.

First, processes in creating the dictionary 23 and the inversion dictionary 24 will be described.

FIG. 4 is a flowchart illustrating an example of the flow of a processing of creating a dictionary. The processing in FIG. 4 is performed by the dictionary creation unit 16 under the control of the CPU 13.

The dictionary creation unit 16 acquires the learning image data group 22 from the ROM 15 under the control of the CPU 13 (S1). Alternatively, the dictionary creation unit 16 may acquire the learning image data group 22 from an external memory.

Next, the dictionary creation unit 16 reads the learning image data group 22 (S2), and creates the dictionary 23 (S3). Here, the dictionary creation unit 16 divides image data of the learning image data group 22 into a plurality of areas, and calculates feature data for each of the divided areas. The dictionary creation unit 16 outputs the created dictionary 23 to the DRAM 14 via the bus 21 to store the dictionary 23 in the DRAM 14.

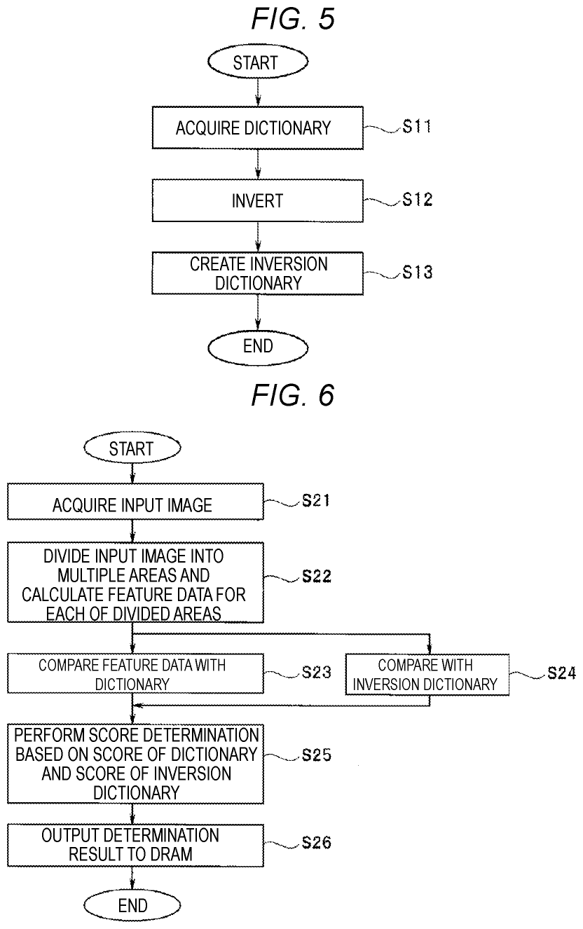

FIG. 5 is a flowchart illustrating an example of the flow of a processing of creating an inversion dictionary. The processing in FIG. 5 is performed by the inversion dictionary creation unit 17 under the control of the CPU 13.

The inversion dictionary creation unit 17 acquires the dictionary 23 from the DRAM 14 under the control of the CPU 13 (S11). The inversion dictionary creation unit 17 inverts the feature data of the dictionary 23 (S12), and creates the inversion dictionary 24 (S13). In particular, the inversion dictionary 24 is created by inverting the feature data of the plurality of divided areas of the dictionary 23, for example, in the horizontal direction. The inversion dictionary creation unit 17 outputs the created inversion dictionary 24 to the DRAM 14 via the bus 21 to store the inversion dictionary 24 in the DRAM 14.

Next, a processing of recognizing an object using the dictionary 23 and the inversion dictionary 24 will be described.

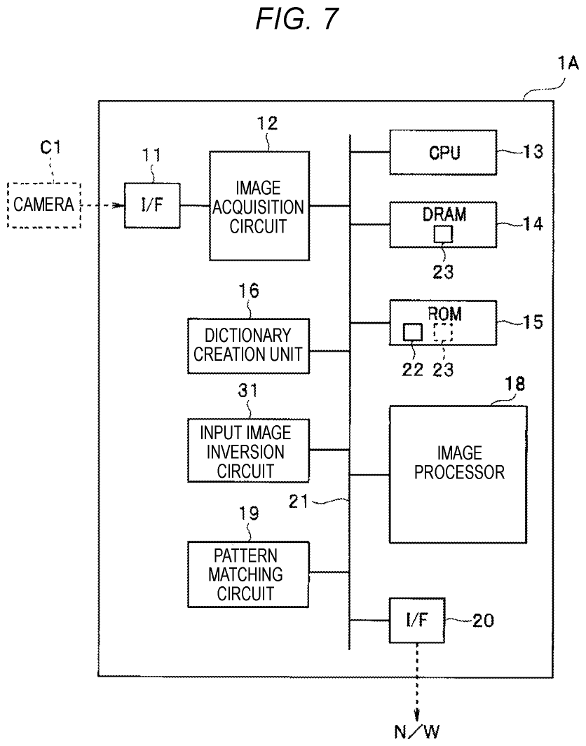

FIG. 6 is a flowchart illustrating an example of the flow of a processing of recognizing an object. The processing in FIG. 6 is performed by the entire image processing apparatus 1 under the control of the CPU 13.

The image acquisition circuit 12 acquires an input image which is a predetermined area of the image from the camera C1 under the control of the CPU 13 (S21). The image processor divides the input image into a plurality of areas, and calculates feature data for each of the plurality of divided areas under the control of the CPU 13 (S22).

The pattern matching circuit 19 calculates a score by comparing the feature data of the dictionary 23 with the feature data of each of the plurality of areas of the input image, under the control of the CPU 13 (S23). In addition, the pattern matching circuit 19 calculates a score by comparing the feature data of the inversion dictionary 24 with the feature data of each of the areas of the input image (S24). For example, the processes in S23 and S24 may be performed at the same time by using a histogram of oriented X (HOX) accelerator that may simultaneously compare the feature data of a plurality of dictionaries with the feature data of the input image as the pattern matching circuit 19.

The pattern matching circuit 19 performs score determination based on the score of the dictionary 23 and the score of the inversion dictionary 24, under the control of the CPU 13 (S25). Here, the pattern matching circuit 19 determines the maximum value or the average value of the score of the dictionary 23 and the score of the inversion dictionary 24 as the final score. The pattern matching circuit 19 outputs the determination result to the DRAM 14 (S26), and terminates the processing.

In related art, an image processing apparatus generates a dictionary from learning images, calculates a score by matching input image data with the dictionary data, and detects a specific object. In such an image processing apparatus, for example, when detecting persons using the dictionary, since the shapes slightly differ depending on their orientation, different dictionaries are generated according to the tendency of the orientation in the learning images, causing variation of the scores resulting from matching the input image with the dictionary.

For example, when there are many persons who face the right side in the learning image, a person dictionary having a large amount of feature data of persons who face the right side is generated. Therefore, when an image of a person who faces the right side is input and is matched with a person dictionary having the large amount of feature data of persons who face the right side, a relatively high score is output. On the other hand, when an image of a person who faces the left side is input and is matched with the dictionary having a large amount of feature data of persons who face the right side, a relatively low score is output, which makes it difficult for the person to be detected.

On the other hand, in the image processing apparatus 1 of the present embodiment, since the feature data of the dictionary 23 and the inversion dictionary 24 in which the feature data of the dictionary 23 is inverted, are compared with the feature data of the input image, and the maximum value or the average value of the scores based on the dictionary 23 and the inversion dictionary 24 is made the final score, variation of the score due to orientation in the dictionary 23 is reduced.

Thus, according to the image processing apparatus of the present embodiment, it is possible to stably detect an object whose shape is very different depending on its orientation.

### Second Embodiment

Next, a second embodiment will be described.

FIG. 7 is a block diagram illustrating a configuration of an image processing apparatus according to a second embodiment. In addition, in FIG. 7, the same reference numerals will be given to the same components as those in FIG. 1, and a description thereof will be omitted.

As illustrated in FIG. 7, the image processing apparatus 1A is configured by removing the inversion dictionary creation unit 17 of the image processing apparatus 1 of FIG. 1. That is, the learning image data group 22 is stored in the ROM 15, and the dictionary 23 created by the dictionary creation unit 16 using the learning image data group 22 is stored in the DRAM 14.

In addition, the image processing apparatus 1A is configured with an input image inversion circuit 31 added to the image processing apparatus 1A of FIG. 1.

An input image acquired by the image acquisition circuit 12 is input to the image processor 18 and to the input image inversion circuit 31 via the bus 21. The input image inversion circuit 31 generates an inverted image by inverting the input image, and outputs the inverted image to the image processor 18.

The image processor 18 compares the feature data of the dictionary 23 with the feature data of the input image from the image acquisition circuit 12 and with the feature data of the inverted image from the input image inversion circuit 31. The pattern matching circuit 19 performs score determination based on the scores obtained based on the input image and the inverted image, and outputs the determination result to the DRAM 14.

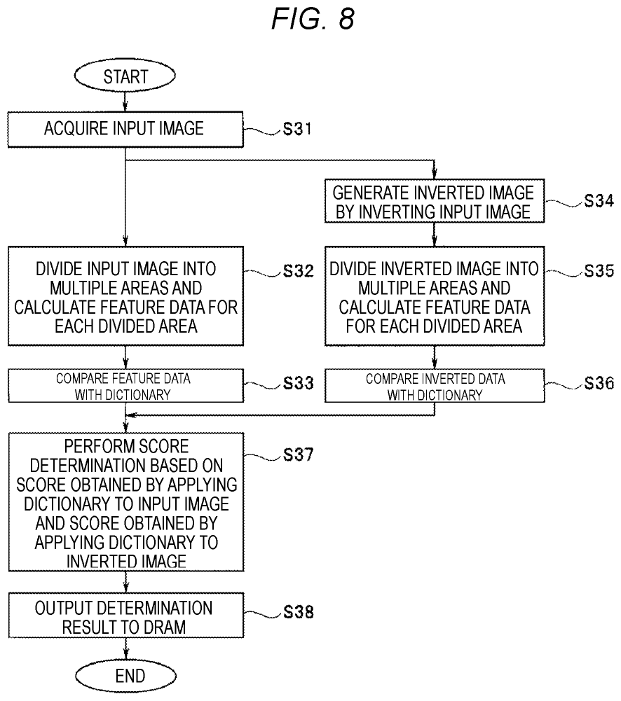

FIG. 8 is a flowchart illustrating an example of the flow of a processing of recognizing an object. The processing in FIG. 8 is performed by the entire image processing apparatus 1A under the control of the CPU 13.

The image acquisition circuit 12 acquires an input image which is a predetermined area of an image from the camera C1 under the control of the CPU 13 (S31). The image processor divides the input image into a plurality of areas, and calculates feature data for each of the plurality of divided areas under the control of the CPU 13 (S32). The pattern matching circuit 19 calculates a score by comparing the feature data of the dictionary 23 with the feature data of the input image (S33).

The input image inversion circuit 31 generates an inverted image by inverting the input image under the control of the CPU 13 (S34). The image processor 18 divides the inverted image into a plurality of areas, and calculates feature data for each of the plurality of divided areas under the control of the CPU 13 (S35). The pattern matching circuit 19 calculates a score by comparing the feature data of the dictionary 23 with the feature data of the inverted image (S36).

The pattern matching circuit 19 performs score determination based on the scores obtained from the input image and the inverted image, under the control of the CPU 13 (S37). Here, the pattern matching circuit 19 determines the maximum value or the average value of the scores obtained based on the input image and the inverted image as the final score. The pattern matching circuit 19 outputs the determination result to the DRAM 14 (S38), and terminates the processing.

As described above, the image processing apparatus 1A compares the feature data of the dictionary 23 with the feature data of the input image and the feature data of the inverted image obtained by inverting the input image. In this way, it is possible to obtain the same effect as that when using the inversion dictionary 24 as stated in the first embodiment. As a result, similarly to the first embodiment, the image processing apparatus 1A of the present embodiment may stably detect an object whose shape is very different depending on its orientation.

### Third Embodiment

Next, a third embodiment will be described.

In the third embodiment, an improvement in the reliability of object detection using symmetry will be described.

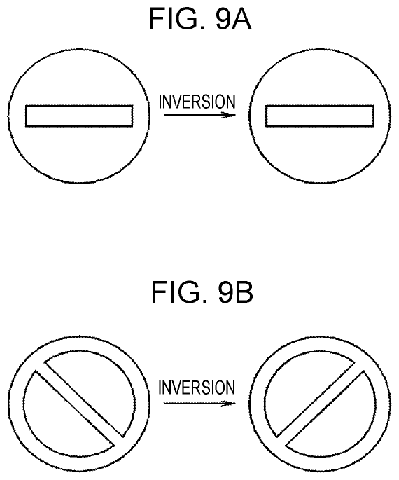

FIGS. 9A and 9B are views illustrating an example of a symmetric object and an asymmetric object. FIGS. 9A and 9B respectively illustrate an example of a traffic sign, FIG. 9A illustrating a symmetric object, and FIG. 9B illustrating an asymmetric object.

The dictionary 23 of an object having symmetry is a dictionary for the detection of the same shape even when the inversion dictionary 24 is created by inverting the dictionary 23. Therefore, in a symmetric object, a score obtained based on the dictionary 23 is equal to a score obtained based on the inversion dictionary 24. For this reason, the symmetric object may be determined to be a detection target object when the score obtained based on the dictionary 23 is equal to the score obtained based on the inversion dictionary 24, and may be determined not to be detection target object when the score obtained based on the dictionary 23 is not equal to the score obtained based on the inversion dictionary 24.

On the other hand, in an asymmetric object, a score obtained based on the dictionary 23 of the asymmetric object becomes higher, and a score obtained based on the inversion dictionary 24 becomes lower. Therefore, the asymmetric object may be determined to be a detection target object when the score obtained based on the inversion dictionary 24 becomes lower, and may be determined not to be a detection target object when the score obtained based on the inversion dictionary 24 does not become lower.

As described above, by comparing the feature data of the dictionary 23 and the inversion dictionary 24 with the feature data of the input image, the image processing apparatus 1 may improve the reliability of detecting the symmetric object and the asymmetric object compared to a case where one dictionary is used.

In addition, the respective steps of the flowchart in the present specification may be changed in the execution order unless it is contrary to the property thereof, may be executed at the same time, or may be executed in a different order for each execution.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit, of the inventions. The accompanying claims and their equivalents are intended to cover such forms or modifications as would fall within the scope and spirit of the inventions.

What is claimed is:

1. An image processing apparatus comprising:
a memory that stores a first dictionary having first feature data of a reference image of a target object and a second dictionary having second feature data of the reference image that is horizontally inverted;
an image processor configured to acquire third feature data of an input image; and
a pattern matching circuit configured to
calculate a first score by comparing the first and third feature data and a second score by comparing the second and third feature data, and
determine whether the target object is present in the input image based on the first and second scores.

2. The image processing apparatus according to claim 1, wherein
the first feature data includes feature data of each of a predetermined number of regions in the reference image,
the second feature data includes feature data of each of a predetermined number of regions in the inverted reference image,
the image processor configured to acquire the third feature data including feature data of each of a predetermined number of regions in the input image, and
the pattern matching circuit is configured to
calculate the first score by comparing the feature data of each region of the input image with the feature data of the corresponding region of the reference image, and
calculate the second score by comparing the feature data of each region of the input image with the feature data of the corresponding region of the inverted reference image.

3. The image processing apparatus according to claim 2, wherein
the feature data of each region is a histogram including edge and color information calculated from pixel data of the region.

4. The image processing apparatus according to claim 3, wherein
the histogram is divided into a predetermined number of sections each corresponding to a different direction, and
the second feature data is generated from the first feature data such that a value representing a first direction in the second feature data is equal to a value representing a second direction opposite to the first direction in the first feature data.

5. The image processing apparatus according to claim 1, wherein
the pattern matching circuit is further configured to
calculate a maximum value or an average value of the first and second scores, and
determine whether the target object is present in the input image based on the maximum or average value.

6. The image processing apparatus according to claim 1, further comprising:
a processor configured to generate the first dictionary based on the reference image stored in the memory.

7. The image processing apparatus according to claim 6, wherein
the processor is further configured to generate the second dictionary based on the generated first dictionary.

8. The image processing apparatus according to claim 1, wherein
the pattern matching circuit is configured to calculate the first and second scores in parallel.

9. The image processing apparatus according to claim 1, further comprising:
an interface connected to a camera to receive the input image.

10. The image processing apparatus according to claim 1, further comprising:
an interface connected to a network installed in an automobile.

11. An image processing apparatus comprising:
a memory that stores a dictionary having first feature data of a reference image of a target object;
an image processor configured to acquire second feature data of an input image and third feature data of the input image that is horizontally inverted; and
a pattern matching circuit configured to
calculate a first score by comparing the first and second feature data and a second score by comparing the first and third feature data, and
determine whether the target object is present in the input image based on the first and second scores.

12. The image processing apparatus according to claim 11, further comprising:
an image processor, wherein
the first feature data includes feature data of each of a predetermined number of regions in the reference image, and
the image processor configured to acquire the second and third feature data including feature data of each of a predetermined number of regions in the input image and the inverted input image, and
the pattern matching circuit is configured to
calculate the first score by comparing the feature data of each region of the input image with the feature data of the corresponding region of the reference image, and
calculate the second score by comparing the feature data of each region of the inverted input image with the feature data of the corresponding region of the reference image.

13. The image processing apparatus according to claim 12, wherein
the feature data of each region is a histogram including edge and color information calculated from pixel data of the region.

14. The image processing apparatus according to claim 13, wherein
the histogram is divided into a predetermined number of sections each corresponding to a different direction, and
the second feature data is generated from the first feature data such that a value representing a first direction in the second feature data is equal to a value representing a second direction opposite to the first direction in the first feature data.

15. The image processing apparatus according to claim 11, wherein
the pattern matching circuit is further configured to
calculate a maximum value or an average value of the first and second scores, and
determine whether the target object is present in the input image based on the maximum or average value.

16. The image processing apparatus according to claim 11, further comprising:
a processor configured to generate the dictionary based on the reference image stored in the memory.

17. The image processing apparatus according to claim 11, wherein
the pattern matching circuit is configured to calculate the first and second scores in parallel.

18. The image processing apparatus according to claim 11, further comprising:
an interface connected to a camera to receive the input image.

19. The image processing apparatus according to claim 11, wherein
an interface connected to a network installed in an automobile.

20. A method for detecting a target object in an input image, the method comprising:
storing in a memory a first dictionary having first feature data of a reference image of a target object and a second dictionary having second feature data of the reference image that is horizontally inverted;
acquiring an input image;
acquiring third feature data of the input image;
calculating a first score by comparing the first and third feature data and a second score by comparing the second and third feature data; and
determining whether the target object is present in the input image based on the first and second scores.
